(19) United States
(12) Patent Application Publication
(10) Pub. No.: US 2016/0106099 A1
(43) Pub. Date: Apr. 21, 2016

(54) MICROBICIDAL COMPOSITION COMPRISING ISOTHIAZOLONE AND AN AMINE OXIDE

(71) Applicant: THOR GMBH, Speyer (DE)

(72) Inventors: Roman GRABBE, Neustadt (DE); Thomas WUNDER, Neustadt a.d. Weinstrasse (DE); Rüdiger BAUM, Waghäusel (DE); Hans-Jürgen SCHMIDT, Speyer (DE); Scott BETTS, Manchester (GB)

(21) Appl. No.: 14/894,395

(22) PCT Filed: May 23, 2014
(86) PCT No.: PCT/EP2014/001392

§ 371 Date: Nov. 27, 2015

(30) Foreign Application Priority Data
May 28, 2013 (EP) 13002756.8

(51) Int. Cl. A01N 43/80; A01N 33/24

(52) U.S. Cl. CPC A01N 43/80; A01N 33/24

(57) ABSTRACT

The present invention relates to a microbicidal composition in the form of a concentrate and to the use of the composition for the preservation of technical and domestic products, preferred for the preservation of detergents and paints.

The present invention relates to a microbicidal composition in the form of a concentrate and to the use of the composition for the preservation of technical and domestic products, preferred for the preservation of detergents, paints and polymer dispersions.

The state of the art discloses a large number of active biocides for the preservation of technical and domestical products. For example isothioazolin-3-one are used as biocides.

EP 1 005 271 B1 discloses a mixture of 2-Methyl-isothiazolinone (MIT) and 1,2-Benzisothiazolinone (BIT). This mixture is sold by Thor GmbH (Speyer, Germany) under the brand name ACTICIDE® MBS.

A combination of an organic amine such as Laurylpropylenediamine and 1,2-Benzisothiazolinone is disclosed in DE 4033272 C1. However, according to the teaching of the state of the art, combinations of certain isothiazolinones with organic amines are not storage-stable.

In view of the state of the art, it is an object of the present invention to provide a microbicidal composition in form of a concentrate which is storage stable and methods for inhibiting the growth of microorganisms, preferably in paints and polymer dispersions. A further object of the present invention is to provide a microbicidal composition comprising at least two biocides which inhibit the growth of microorganisms synergistically in the presence of each other.

Microbicidal composition which comprises:
a) as a first antimicrobial compound 2-methylisothiazolin-3-one (MIT) and
b) as a second compound at least one amine oxide having the general formula ONR¹R²R³, wherein R¹, R² and R³ are independently selected from C₁ to C₁₈ straight-chained or branched-chained alkyl and C₁ to C₄ hydroxyalkyl, [CH₂CH₂O]ₙH or [CH₂CH₂CH₂O]ₙH, wherein n is an integer from 1 to 4.

The composition of the invention is characterized in that a weight ratio of a) to b) is from 1:20 to 10:1, more preferred from 1:15 to 5:1.

The present invention is based inter alia on the fact that it has surprisingly been found that a component(s) of group a) and the component(s) of group b) interact synergistically, thereby making it possible to lower the required use concentration of the individual compounds. Accordingly, it is possible in numerous fields of application to lower the sensitizing effect of the compositions comprising isothiazolones and to improve their environmental compatibility. At the same time it is possible to lower the costs as compared with known single biocide preparations. A further advantage of a biocide composition of the invention, in addition to its surprisingly broad activity spectrum, lies in its long-term stability and long-term activity.

The microbicidal composition of the invention is particularly suitable for the preservation of water based products. Water based products such as water based detergents, water based paints, polymer dispersions and polymer emulsions often suffer from microbial infection. These products with a pH within about pH 3 to pH 9.5 will most likely suffer from wet state fungal contamination. In these products, good technical preservation against fungi is difficult as many fungicidal active ingredients or compositions are too toxic and or too expensive. The microbicidal composition of the invention overcomes these drawbacks as the biocidal compositions shows good technical performance against fungi which should offer a reduced toxicity by the fact that more toxic fungicides are not needed to preserve the preferred product/system.

The first component a) of the composition of the invention is the isothiazolone-family biocide 2-methylisothiazolin-3-one (MIT). According to a preferred embodiment of the invention component a) is MIT, and the presence of further isothiazolones is in this case preferably excluded.

A further development of the invention proposes that the microbicidal composition is essentially free from halogenated isothiazolone. “Essentially” free is taken to mean that the composition has from 0 to at most 3%, preferably from 0 to 1%, and further preferably from 0 to only 0.5%, halogenated isothiazolones, based on the combined weight of halogenated isothiazolone and MIT. Furthermore, it is preferred that the microbicidal composition of the present invention comprises no 5-chloro-2-methlyisothiazolin-3-one (CMIT) that means 0.01 to only 0.5%, CMIT, based on the combined weight of CMIT and MIT. According to a further preferred embodiment, the microbicidal composition preferably comprises no chlorine-containing isothiazolone.

The concentration of MIT, component a), in the concentrate is preferably 0.1% to 25% by weight, more preferably 1 to 10% by weight, in particular 2 to 8% by weight, such as for example 4% by weight (stated as pure active ingredient), based on the weight of the composition.

The at least one organic amine oxide used as component b) is a component having the general formula ONR¹R²R³, wherein R¹, R² and R³ are independently selected from C₁ to C₁₈ straight-chained or branched-chained alkyl and C₁ to C₄ hydroxyalkyl, [CH₂CH₂O]ₙH or [CH₂CH₂CH₂O]ₙH, wherein n is an integer from 1 to 4. According to a preferred embodiment of the invention, R¹ and R² are Methyl. According to a further preferred embodiment of the invention, R¹ and R² are Methyl and R³ is a straight chained alkyl radical having 10 to 14 C atoms.

Due to the production process of the at least one organic amine oxide used as component b), the amine oxide contains a certain amount of amine(s) (as a by-product). That means, that the microbicidal composition of the invention comprises from 0 to at most 3%, preferably from 0 to 1%, and further preferably from 0 to only 0.5%, amines, based on the combined weight of amines and amine oxides present in the composition.

According to a preferred embodiment of the invention, the amine oxide, component b) of the invention, is selected from the group consisting of N,N-dimethylcocoalkylamine oxide, N,N-dimethyldecylamine-N-oxide, N,N-dimethyldodecylamine-N-oxide N,N-dicocoalkylmethylamine-N-oxide, N,N-didecylmethylamine-N-oxide, N,N-didodecylmethylamine-N-oxide, N,N-Di-tetradecane-1-methylamine-N-oxide and N,N-Dimethyl-1-tetradecanamine-N-oxide. According to a more preferred embodiment of the invention the amine oxide is N,N-dimethyldodecylamine-N-Oxide.

The concentration of the amine oxide, component b), in the concentrate is preferably 5 to 50% by weight, more preferably 10 to 30%, based on the weight of the composition.

According to a further embodiment of the invention, the microbicidal composition comprises as a third antimicrobial compound c) one or more antimicrobial compounds selected from the group consisting of 2-n-octyl-4-isothiazolin-3-one (OIT), 3-iodo-2-propynl butyl-carbamate (IPBC), 1,2-Benzisothiazolin-3-one (BIT), 2-alkyl-1,2-Benzisothiazolin-3-ones with alkyl groups containing 1 to 6 carbon atoms such as N-methyl-1,2-Benzisothiazolin-3-one (Me-BIT) and N-butyl-1,2-Benzisothiazolin-3-one (Butyl-BIT), Dithio-2,2′-bis-(DTBMA), sodium pyrithione (NaPy), zinc pyrithione (ZnPy), 5-chloro-2-methyl-3-isothiazolone (CMIT), diiodomethyl-p-tolylsulfone (DIMTS), ortho-phenylphenol (OPP) and 4,5-dichloro-2-n-octyl-4-isothiazolin-3-one (DCOIT).

According to a preferred embodiment of the invention, the third antimicrobial compound c) of the invention, is selected from the group consisting of 2-n-octyl-4-isothiazolin-3-one (OIT), 3-iodo-2-propynl butylcarbamate (IPBC), N-methyl-1,2-Benzisothiazolin-3-one (Me-BIT) and 1,2-Benzisothiazolin-3-one (BIT).

The concentration of component c) in the concentrate is preferably 0.1 to 25% by weight, more preferably 1 to 10% by weight, based on the weight of the composition.

According to a further embodiment of the invention, the microbicidal composition also comprises d), one or more chelating agent(s). Preferred chelating agents are selected from the group consisting of 1-Hydroxyethane1,1-diphosphonic acid (HEDP), Amino tris (methylene phosphonic acid) (ATMP), Ethylenediamine tetra (methylene phosphonic acid) (ETMP), Diethylenetriamine penta (methylene phosphonic acid) (DTPMP), Hydroxyethyl-amino bis (methylene phosphonic acid) (HEMPA), 2-Phosphonobutane-1,2,4-tricarboxylic acid (PBTC), ethylene diamine tetraacetic acid (EDTA), diethylene triamine pentaacetic acid (DTPA), N-(hydroxyethyl)ethylene-diaminetriacetic acid, methylglycinediacetic acid (MGDA), Nitrilotriacetic acid (NTA), Diamine alkoxylates and, Carboxy functionalized amines. According to a more preferred embodiment of the invention the chaleting agent is ethylene diamine tetraacetic acid (EDTA), 1-Hydroxyethane1,1-diphosphonic acid (HEDP) and/or methylglycinediacetic acid (MGDA).

The concentration of the chelating agent d) (if present) in the concentrate is preferably 5 to 50% by weight, more preferably 10 to 30% by weight, based on the weight of the composition.

The composition according to the invention optionally comprises e) solvents and/or f) further microbicidal active ingredients, functional additives or auxiliaries.

Suitable solvents, component e) are water, alcohols, such as ethanol, propanol, benzyl alcohol, glycols such as ehtlyene glycol, propylene glycols such as dipropylene glycol, butanediols, glycol ethers, such butyl glycol, butyl diglycol, phenoxyethanol, phenoxypropanols, polyols, such as glycerol, alcanediols and alkyl glycerol ethers and mixtures thereof. Preference is given to using VOC (volatile organic compounds)-free or low VOC solvents. The solvent is preferably water.

The concentration of component e) in the concentrate is preferably 30 to 98% by weight, more preferably 40 to 80% by weight, in particular 50 to 80% by weight, based on the weight of the composition.

The concentrate preferably comprises water in an amount of from 30 to 98% by weight, more preferably 40 to 80% by weight, in particular 50 to 80% by weight, based on the weight of the composition.

Suitable functional additives, component f), are: thickeners, fillers, antioxidants, such as vitamin E, BHA and BHT, alkalizing agents, such as NaOH, KOH, alkali metal carbonate, alkali metal hydrogen carbonate, ammonia, low molecular weight amines or alkanolamines, acidifying agents, such as HCl, carboxylic acids, such as acetic acid, preferably hydroxy carboxylic acids, such as lactic acids, citric acid, buffers, corrosion inhibitors (such as benzotriazole), wetting agents and low-temperature stabilizers.

The concentrates according to the invention are preferably clear and homogenous and are in the form of liquids, preferably aqueous solutions. They are adequately colour-stable, low-temperature-stable, storage-stable and active-ingredient-stable.

The pH of the concentrate is preferably in the range of from 2 to 5, more preferably in the range of from 2.5 to 4.

The concentrates of the composition of the invention are further characterized in that a weight ratio of a) to b) to c) is from 1:10 to 10:1 to 1:10 to 10:1 to 1:10 to 10:1, more preferred from 1:5 to 5:1 to 1:5 to 5:1 to 1:5 to 5:1.

Preference is given to a liquid concentrate which comprises or consists of:
(a) MIT and
(b) at least one amine oxide having the general formula ONR¹R²R³, wherein R¹, R² and R³ are independently selected from C₁ to C₁₈ straight-chained or branched-chained alkyl and C₁ to C₄ hydroxyalkyl, [CH₂CH₂O]ₙH or [CH₂CH₂CH₂O]ₙH, wherein n is an integer from 1 to 4,
(c) at least one antimicrobial compound selected from the group consisting of OIT, IPBC, BIT, Me-BIT, Butyl-BIT, DTBMA, NaPy, ZnPy, CMIT, DIMTS, OPP and DCOIT,
(d) at least one or more chelating agent(s),
(e) at least one solvent (preferably water), and
(f) optionally further microbicidal active ingredients, functional additives or auxiliaries.

The present invention also relates to the use of the microbicidal composition, comprising the components (a), (b) and (c), or comprising the components (a), (b) and (d), or comprising the components (a), (b), (c) and (d) for the preservation of technical or domestic products. Accordingly, the invention relates to a technical or domestic product which preferably comprises 0.001 to 1.0% by weight, more preferably 0.01 to 0.5% by weight of the composition according to the invention.

Examples of products are preferably water based or water-dilutable products of all types. Examples of products are technical products selected from polymer dispersions, polymer emulsions, paints, adhesives, paper coating compositions, textile softening and sizing compositions, cleaning and polishing compositions, cosmetic and pharmaceutical preparations, household products, pack preservatives, spinning baths, cooling lubricants, leather treatment compositions, wet wipes and silicone and bitumen emulsions. Preferred products are selected from the group consisting of cleaning and polishing compositions, household products and wet wipes.

The components (a) and (b) or (a), (b) and (d) of the composition of the present invention may—preferably—be present in a product, e.g. a liquid concentrate, and be dosed into the end product or intermediate product to be preserved in a known manner. The components (a) and (b) or (a), (b) and (d) may, however, also be present in two or more separate products (solid and/or liquid) and be dosed into the end product or intermediate product to be preserved in a known manner.

The present invention is further directed to a technical or domestical product, e.g. an application solution comprising:
(a) 10 to 300 ppm of MIT, preferably 25 to 150 ppm of MIT and
(b) 50 to 5000 ppm amine oxide, preferably 100 to 1000 ppm of amine oxide, and, if present
(c) optionally 10 to 300 ppm, preferably 25 to 150 ppm at least one antimicrobial compound selected from the group consisting of OIT, IPBC, BIT, Me-BIT, Butyl-BIT, DTBMA, NaPy, ZnPy, CMIT, DIMTS, OPP and DCOIT,
(d) optionally 50 to 5000 ppm, preferably 100 to 1000 ppm of at least one or more chelating agent(s).

Examples of the above defined products are polymer dispersions, paints, adhesives, paper coating compositions, textile softening and sizing compositions, cleaning and polishing compositions, cosmetic and pharmaceutical preparations, household products, pack preservatives, spinning baths, cooling lubricants, leather treatment compositions, wet wipes and silicone and bitumen emulsions. Preferred products are selected from detergents, paints and polymer dispersions. The pH of the preferred products is preferably within pH 3 to pH 9.5.

Preferred products are low in anionic surfactants and preferably comprise less than 5% by weight of anionic surfactants.

### EXAMPLES

The following examples and the applications are intended to illustrate the invention more closely but without restricting it thereto. All percentage details are percentages by weight (% by weight), if not explicitly stated otherwise.

### Investigation of the Synergistic Effect

The synergism of a combination of 2-Methyl-isothiazolinone (MIT) with N,N-Dimethyldodecan-1-amine oxide was tested. Test organisms used was the mould Aspergillus niger (DSM 12623). For the purpose of the test, mixtures containing different concentrations of MIT and N,N-Dimethyldodecan-1-amine oxide were prepared and tested for their action on Aspergillus niger. The active compound mixtures in the corresponding concentrations were introduced into selective nutrient media (Sabouraud glucose agar for Aspergillus niger and the test organisms were likewise incorporated into the agar. The cell density in the agar was in each case 3,7·10⁶ spores per ml for Aspergillus niger. The incubation time is 72 hours at 25° C. This was followed by visual testing for growth of Aspergillus niger. The growth was apparent through the formation of colonies or mycelia on the surface of the agar. In this way the minimum inhibitory concentrations (MICs) of the two active compounds were determined, individually and in combination. The MIC is the concentration at which there is no formation of colonies or mycelia on the surface of the agar (Aspergillus niger).

The synergism that occurred was presented numerically by calculation of the synergy index (SI). This calculation was made using the common method of F. C. Kull et al., Applied Microbiology, vol. 9 (1961), p. 538. SI is calculated there in accordance with the following formula:

Synergy index SI=Qa/QA+Qb/QB

In the application of this formula to the MIT+N,N-Dimethyldodecan-1-amine oxide biocide system tested here, the variables in the formula have the following definition:

Qa=concentration of MIT in the mixture of N,N-Dimethyldodecan-1-amine oxide+MIT
QA=concentration of MIT as sole biocide
Qb=concentration of N,N-Dimethyldodecan-1-amine oxide in the biocide mixture of N,N-Dimethyldodecan-1-amine oxide+MIT
QB=concentration of N,N-Dimethyldodecan-1-amine oxide as sole biocide

If the synergy index has a value of more than 1, this means that there is an antagonism. If the synergy index adopts a value of 1, this means that the action of the two biocides is additive. If the synergy index takes on a value of below 1, this means that there is synergism of the two biocides.

### Example 1

### Determination of the Synergy Index of N,N-Dimethyldodecan-1-amine oxide+MIT in Respect of Aspergillus niger for an Incubation Time of 72 Hours at 25° C.

TABLE 1

| | | Synergistic |
|---|---|---|
| MHK Qa | MHK Qb | Index |
| (MIT) | (Amine oxide) | Qa/QA + |
| [ppm] | [ppm] | Qb/QB |
| 0 | 231 (MIC) | 1.00 |
| 10 | 165 | 0.72 |
| 20 | 99 | 0.45 |
| 40 | 66 | 0.33 |
| 60 | 49.5 | 0.27 |
| 80 | 33 | 0.22 |
| 120 | 16.5 | 0.19 |
| 1000 (MIC) | 0 | 1.00 |

From Table 1 it is evident that the optimum synergy, i.e. the lowest synergy index (0.19) of a biocide composition composed of MIT and N,N-Dimethyldodecan-1-amine oxide, is present at 16.5 ppm by weight N,N-Dimethyldodecan-1-amine oxide and 120 ppm MIT.

### Example 2

### Determination of the Synergy Index According to Kull et al. of N,N-Dimethyldodecan-1-amine oxide+MIT in Respect of Candida albicans (ATCC 10231)

The cell density of Candida albicans (ATCC 10231) was 10⁶/ml, incubation time 72 hours, temperature 25° C. The results were shown in table 3.

TABLE 2

| | | | | | Synergistic |
|---|---|---|---|---|---|
| MHK Qa | MHK Qb | | | | Index |
| (MIT) | (Amine oxide) | Total | | | Qa/QA + |
| [ppm] | [ppm] | [ppm] | Qa/QA | Qb/QB | Qb/QB |
| 125 | 0 | 125 | 1.00 | 0.00 | 1.00 |
| 75 | 5 | 80 | 0.60 | 0.10 | 0.70 |
| 75 | 10 | 85 | 0.60 | 0.20 | 0.80 |
| 50 | 15 | 65 | 0.40 | 0.30 | 0.70 |
| 40 | 20 | 60 | 0.32 | 0.40 | 0.72 |
| 30 | 25 | 55 | 0.24 | 0.50 | 0.74 |
| 30 | 30 | 60 | 0.24 | 0.60 | 0.84 |
| 20 | 35 | 55 | 0.16 | 0.70 | 0.86 |
| 10 | 40 | 50 | 0.08 | 0.80 | 0.88 |
| 0 | 50 | 50 | 0.00 | 1.00 | 1.00 |

Qa = concentration of MIT in the mixture of N,N-Dimethyldodecan-1-amine oxide + MIT
QA = concentration of MIT as sole biocide
Qb = concentration of N,N-Dimethyldodecan-1-amine oxide in the biocide mixture of N,N-Dimethyldodecan-1-amine oxide + MIT
QB = concentration of N,N-Dimethyldodecan-1-amine oxide as sole biocide

From Table 2 it is evident that the optimum synergy, i.e. the lowest synergy index (0.70) of a biocide composition composed of MIT and Dimethyldodecan-1-amine oxide, is present at a ratio of 23.1% by weight Dimethyldodecan-1-amine oxide to 76.9% by weight MIT. The synergistic range is from (MIT: Amine oxide) 75:5 to 10:40.

### Example 3

### Determination of the Synergy Index According to Kull et al. of N,N-Dimethyldodecan-1-amine oxide+MIT+2-n-octyl-4-isothiazolin-3-one (OIT) in Respect of Candida albicans (ATCC 10231)

The cell density of Candida albicans (ATCC 10231) was 10⁶/ml, incubation time 72 hours, temperature 25° C. The results were shown in table 3.

TABLE 3

| MHK | MHK Qa | MHK | | | | |
|---|---|---|---|---|---|---|
| Qa | (Amine | Qb | | | | |
| (MIT) | oxide) | (OIT) | Total | | | Synergistic |
| [ppm] | [ppm] | [ppm] | [ppm] | Qa/QA | Qb/QB | Index |
| 0 | 0 | 3 | 3 | 0.00 | 1.00 | 1.00 |
| 3.5 | 2.5 | 1 | 4.5 | 0.20 | 0.33 | 0.53 |
| 10.5 | 7.5 | 0.5 | 11 | 0.60 | 0.17 | 0.77 |
| 17.5 | 12.5 | 0 | 17.5 | 1.00 | 0.00 | 1.00 |

Qa = concentration of MIT in the mixture of N,N-Dimethyldodecan-1-amine oxide + MIT
QA = concentration of MIT as sole biocide
Qb = concentration of N,N-Dimethyldodecan-1-amine oxide in the biocide mixture of N,N-Dimethyldodecan-1-amine oxide + MIT
QB = concentration of N,N-Dimethyldodecan-1-amine oxide as sole biocide

1. Microbicidal composition which comprises:
a) as a first antimicrobial compound 2-methylisothiazolin-3-one (MIT) and b) as a second compound at least one amine oxide having the general formula ONR¹R²R³, wherein R¹, R² and R³ are independently selected from Q to C₁₈ straight-chained or branched-chained alkyl and C\ to C₄ hydroxyalkyl, [CH₂CH₂0]ₙH or [CH₂CH₂CH₂0]ₙH, wherein n is an integer from 1 to 4, characterized in that a ratio of a) to b) is from 1:20 to 10:1.

2. Composition according to claim 1, characterized in that it also comprises as a third antimicrobial compound c) one or more antimicrobial compounds selected from the group consisting of 2-n-octyl-4-isothiazolin-3-one (OIT), 3-iodo-2-propynl butyl-carbamate (IPBC), 1,2-Benzisothiazolin-3-one (BIT), N-methyl-1,2 Benzisothia-zolin-3-one (Me-BIT), N-butyl-1,2 Benzisothiazolin-3-one (Butyl-BIT), Dithio-2,2′-bis-benzmethylamide (DTBMA), sodium pyrithione (NaPy), zinc pyrithione (ZnPy), 5-chloro-2-methyl-3-isothiazolone (CMIT), diiodomethyl-p-tolylsulfone (DIMTS), ortho-phenylphenol (OPP) and 4,5-dichloro-2-n-octyl-4-isothiazolin-3-one (DCOIT).

3. Composition according to claim 1, characterized in that it also comprises d), one or more chelating agents.

4. Composition according to claim 1, characterized in that the amine oxide is selected from the group consisting of N,N-dimethylcocoalkylamine oxide, N,N-dimethyldecylamine-N-oxide, N,N-dimethyldodecylamine-N-oxide N,N-dicocoalkylmethylamine-N-oxide, N,N-didecylmethylamine-N-oxide, N,N-didodecylmethylamine-N-oxide, N,N-Di-tetradecane-1-methylamine-N-oxide and N,N-Dimethyl-1-tetradecanamine-N-oxide. According to a more preferred embodiment of the invention the amine oxide is N,N-dimethyldodecylamine-N-Oxide.

5. Composition according to claim 1, characterized in that the chelating agent is selected from the group consisting of 1-Hydroxyethane1,1-diphosphonic acid (HEDP), Amino tris (methylene phosphonic acid) (ATMP), Ethylenediamine tetra (methylene phosphonic acid) (ETMP), Diethylenetriamine penta (methylene phosphonic acid) (DTPMP), Hydroxyethylamino bis (methylene phosphonic acid) (HEMP A), 2-Phosphonobutane-1,2,4-tricarboxylic acid (PBTC), ethylene diamine tetraacetic acid (EDTA), diethylene triamine pentaacetic acid (DTPA), N-(hydroxyethyl)ethylene-diaminetriacetic acid, methylglycinediacetic acid (MGDA), Nitrilotriacetic acid (NT A), Diamine alkoxylates and, Carboxy functionalized amines.

6. Composition according to claim 1, characterized in that the amount of component a) is 0.1% to 25% by weight.

7. Composition according to claim 1, characterized in that the amount of component b) is 5% to 50% by weight.

8. Composition according to claim 2, characterized in that the amount of component c), if present, is 0.1 to 25% by weight.

9. Use of a composition according to claim 1 for the preservation of technical or domestic products.

11. Use according to claim 10, characterized in that the technical product is selected from polymer dispersions, paints, adhesives, paper coating compositions, textile softening and sizing compositions, cleaning and polishing compositions, cosmetic and pharmaceutical preparations, household products, pack preservatives, spinning baths, cooling lubricants, leather treatment compositions, wet wipes and silicone and bitumen emulsions.

12. Technical or domestic product which comprises 0.01 to 1% by weight of the antimicrobial compounds a) and b) of the composition according to claim 1.

13. Technical product according to claim 12, selected from the group consisting of polymer dispersions, paints, adhesives, paper coating compositions, textile softening and sizing compositions, cleaning and polishing compositions, cosmetic and pharmaceutical preparations, household products, pack preservatives, spinning baths, cooling lubricants, leather treatment compositions, wet wipes and silicone and bitumen emulsions.
